(19) United States
(12) Patent Application Publication
(10) Pub. No.: US 2026/0205039 A1
(43) Pub. Date: Jul. 16, 2026

(54) Motor Control Device and Electric Drive Vehicle

(71) Applicant: Astemo, Ltd., Chiyoda-ku, Tokyo (JP)

(72) Inventors: Shun TANIGUCHI, Tokyo (JP); Kentaro MATSUO, Hitachinaka (JP); Toshiyuki AJIMA, Tokyo (JP)

(21) Appl. No.: 19/135,269

(22) PCT Filed: Aug. 25, 2023
(86) PCT No.: PCT/JP2023/030644

§ 371 Date: Jun. 3, 2025

(30) Foreign Application Priority Data
Dec. 15, 2022 (JP) 2022-200465

(51) Int. Cl. H02P 21/05; H02P 27/08

(52) U.S. Cl. CPC H02P 21/05; H02P 27/085

(57) ABSTRACT

Provided is a motor control device that outputs voltage to be applied to an AC motor based on an output voltage command value, the motor control device including: a control period determination unit that determines a control period in accordance with a fundamental wave frequency of the AC motor and a cutoff frequency of current control; a control interrupt unit that determines a control interrupt based on the control period determined by the control period determination unit; a current controller that controls the output voltage command value based on the control interrupt determined by the control interrupt unit; and a PWM controller that controls output of voltage by PWM in accordance with the output voltage command value controlled by the current controller. This configuration enables vibration of a current due to a 6n-th-order harmonic current component to be more easily suppressed when control is performed in which a control period is not synchronized with an inverter frequency.

### TECHNICAL FIELD

The present invention relates to a motor control device and an electric drive vehicle.

### BACKGROUND ART

To improve a voltage utilization rate of an inverter in a control system of an AC motor mounted on an electric drive vehicle or the like, known techniques include a technique of operating in an overmodulation mode (so-called overmodulation region) in which an output voltage command of the inverter exceeds a maximum output level that can be output by a sine wave, a technique of synchronous PWM for outputting a PWM pulse in synchronization with an inverter output frequency, and the like.

Meanwhile, the overmodulation region and the synchronous PWM each include a current in a dq-axis coordinate system used in vector control, the current including a 6n-th-order harmonic current (where n is a natural number) due to switching of the inverter, and thus causing a problem of generating current vibration due to the harmonic current.

Known examples of a technique related to suppression of the harmonic current described above include techniques described in PTLs 1 and 2.

PTL 1 discloses a current detection device of a synchronous PWM power converter including: a power conversion main circuit that applies voltage for driving an AC power load; a voltage command value generation unit that outputs a command value of each of a modulation rate and a phase angle of the voltage; a PWM control signal generation unit that generates a PWM control signal based on the command value of each of the modulation rate and the phase angle and outputs the PWM control signal to the power conversion main circuit; a current detection unit that detects a current supplied to the AC power load and outputs a current signal corresponding to the current; and a sampling unit that samples and holds a current detection value based on the current signal and outputs a first sample hold value, the sampling unit including a voltage phase angle setting unit in which a predetermined phase angle is set to serve as sampling timing, and the sampling unit sampling and holding the current detection value at timing when the command value of the phase angle equals the set value of the predetermined phase angle.

NPL 1 discloses a filter design method based on an approach using a filter for a purpose of preventing control performance deterioration by reducing sensitivity of a current control system to a disturbance component superimposed in an overmodulation region.

### CITATION LIST

### Patent Literature

PTL 1: JP 2004-15949 A

### Non Patent Literature

NPL 1: “Design of band elimination filter enabling PMSM vector control in inverter overmodulation region”, Yousuke Nakayama and Shinji Michiki, IEEJ Journal D, Vol. 138, No. 11, pp. 884-893 (2018)

### SUMMARY OF INVENTION

### Technical Problem

PTL 1 describes a harmonic current that is suppressed by detecting a current at timing when the harmonic current becomes zero by synchronizing a carrier frequency with an inverter output frequency. Unfortunately, when this way is applied to an application such as an automobile that needs to be rapidly accelerated and decelerated, for example, a control period is less likely to synchronize with an inverter frequency because the control period is frequently changed by the frequency.

NPL 1 describes the overmodulation region in which sixth-order component of a current is removed, so that a control cycle can be made constant. Unfortunately, a band removal filter used to remove a harmonic needs to be changed in accordance with an inverter output frequency, so that correspondence to a high-speed calculation period is required to remove a target frequency.

The present invention has been made in view of the above, and an object of the present invention is to provide a motor control device and an electric drive vehicle that are capable of more easily suppressing current vibration caused by a 6n-th harmonic current component when control is performed in which a control cycle is not synchronized with an inverter frequency.

### Solution to Problem

The present application includes a plurality of means for solving the above problem, and an example thereof is a motor control device that outputs voltage to be applied to an AC motor based on an output voltage command value, the motor control device including: a control period determination unit that determines a control period in accordance with a fundamental wave frequency of the AC motor and a cutoff frequency of current control; a control interrupt unit that determines a control interrupt based on the control period determined by the control period determination unit; a current controller that controls the output voltage command value based on the control interrupt determined by the control interrupt unit; and a PWM controller that controls output of voltage by PWM in accordance with the output voltage command value controlled by the current controller.

### Advantageous Effects of Invention

The present invention enables vibration of a current due to a 6n-th-order harmonic current component to be more easily suppressed when control is performed in which a control period is not synchronized with an inverter frequency.

### BRIEF DESCRIPTION OF DRAWINGS

FIG. 1 is a functional block diagram illustrating a motor control device according to a first embodiment together with a related configuration.

FIG. 2 is a diagram illustrating a relationship among a three-phase fundamental wave current, a dq-axis sixth-order harmonic current, and reading timing.

FIG. 3 is a diagram illustrating an example of a lookup table according to the first embodiment.

FIG. 4 is a diagram illustrating a first modification of the lookup table.

FIG. 5 is a diagram illustrating a second modification of the lookup table.

FIG. 6 is a diagram illustrating a third modification of the lookup table.

FIG. 7 is a functional block diagram illustrating a motor control device according to a second embodiment together with a related configuration.

FIG. 8 is a diagram illustrating a relationship among a three-phase fundamental wave current, a dq-axis sixth-order harmonic current, and reading timing.

FIG. 9 is a diagram illustrating an example of a lookup table according to the second embodiment.

FIG. 10 is a diagram illustrating a relationship among a three-phase fundamental wave current, a dq-axis sixth-order harmonic current, and reading timing.

FIG. 11 is a functional block diagram illustrating a motor control device according to a third embodiment together with a related configuration.

FIG. 12 is a functional block diagram illustrating processing contents of a control period calculation unit according to the third embodiment.

FIG. 13 is a diagram illustrating an example of a lookup table according to the third embodiment.

FIG. 14 is a functional block diagram illustrating a motor control device according to a fourth embodiment together with a related configuration.

FIG. 15 is a functional block diagram illustrating processing contents of a control period calculation unit according to the fourth embodiment.

FIG. 16 is a functional block diagram illustrating a motor control device according to a fifth embodiment together with a related configuration.

FIG. 17 is a functional block diagram illustrating processing contents of a control period calculation unit according to the fifth embodiment.

FIG. 18 is a functional block diagram illustrating a motor control device according to a sixth embodiment together with a related configuration.

FIG. 19 is a diagram illustrating a relationship among a three-phase fundamental wave current, a dq-axis sixth-order harmonic current, and reading timing.

FIG. 20 is a diagram schematically illustrating a drive system of an electric drive vehicle equipped with an AC motor controlled by a motor control device taken out together with a control system.

### DESCRIPTION OF EMBODIMENTS

Hereinafter, embodiments of the present invention will be described with reference to the drawings. Although the following description exemplifies a permanent magnet synchronous motor (PMSM) of an AC motor is as a control target of a motor control device, the control target is not limited thereto. For example, AC machines such as a synchronous reluctance motor, a permanent magnet synchronous generator, a winding-type synchronous machine, an induction motor, and an induction generator can obtain similar effect by applying the present invention. Although the following description also exemplifies an IGBT as a semiconductor switching element of an inverter device, the semiconductor switching element is not limited thereto. For example, even when a MOSFET or another power semiconductor element is used, similar effect can be obtained by applying the present invention.

### First Embodiment

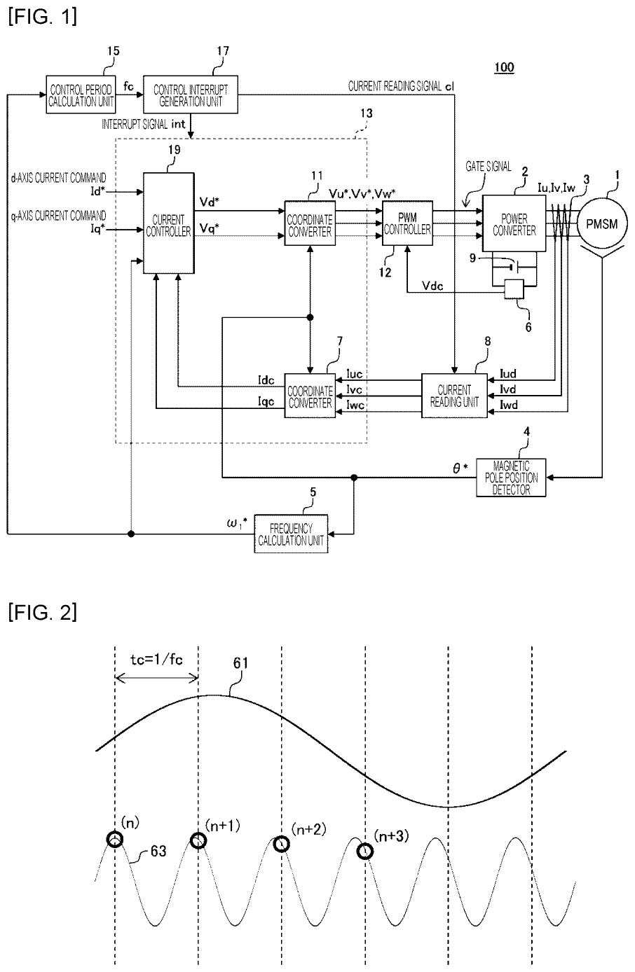

A first embodiment of the present invention will be described with reference to FIGS. 1 to 6, and 20.

FIG. 1 is a functional block diagram illustrating a motor control device according to the present embodiment together with a related configuration. FIG. 20 is a diagram schematically illustrating a drive system of an electric drive vehicle equipped with an AC motor controlled by a motor control device taken out together with a control system.

As illustrated in FIG. 20, a motor control device 100 according to the present embodiment controls power supplied from a DC voltage source 9 (e.g., a battery) to a PMSM 1 through a power converter 2 (inverter).

The PMSM 1 is connected to a drive shaft 105 through a transmission 101 and a differential gear gear 103, and supplies power to a wheel 107.

Although an example will be described in the present embodiment in which power from the PMSM 1 is transmitted through the transmission 101, the present invention is not limited thereto. For example, the present invention can also be applied to a configuration in which the PMSM is directly connected to a differential gear or a configuration in which a front wheel and a rear wheel each include the PMSM and the inverter.

As illustrated in FIG. 1, the motor control device 100 controls power supplied from the DC voltage source 9 to the PMSM 1 through the power converter 2, and schematically includes a phase current detector 3, a magnetic pole position detector 4, a frequency calculation unit 5, a DC voltage detection device 6, coordinate converters 7 and 11, a current reading unit 8, a PWM controller 12, a control period calculation unit 15, a control interrupt generation unit 17, and a current controller 19. The coordinate converters 7 and 11, and the current controller 19 constitute a control calculation unit 13.

The power converter 2 converts DC power from the DC voltage source 9 (e.g., a battery) into AC power according to a gate signal from the PWM controller 12, and outputs the AC power to drive the PMSM 1.

The phase current detector 3 includes a hole current transformer (CT), for example, and detects respectively current waveforms Iud, Ivd, and Iwd of a U phase, a V phase, and a W phase of a three-phase current flowing from the power converter 2 to the PMSM 1.

The magnetic pole position detector 4 includes a resolver, for example, and detects a magnetic pole position of the PMSM 1 and outputs the magnetic pole position as magnetic pole position information θ*.

The frequency calculation unit 5 calculates an angular velocity from the magnetic pole position information ex detected by the magnetic pole position detector 4 by differential calculation, for example, and outputs the angular velocity as velocity information ω1*.

The current reading unit 8 reads the current waveforms Iud, Ivd, and Iwd detected by the phase current detector 3 at timing when a current reading signal cl from the control interrupt generation unit 17 becomes ON, and outputs respectively the current waveforms Iud, Ivd, and Iwd as three-phase currents Iuc, Ivc, and Iwc to the coordinate converter 7 of the control calculation unit 13.

The coordinate converter 7 calculates and outputs dq-axis current detection values Idc and Iqc by coordinate-transforming the three-phase currents Iuc, Ivc, and Iwc read by the current reading unit 8 based on the magnetic pole position information θ* detected by the magnetic pole position detector 4.

The current controller 19 calculates dq-axis voltage command values Vd* and Vq* to allow dq-axis current command values Id* and Iq* to equal dq-axis current detection values Idc and Iqc from the coordinate converter 7, respectively, and outputs the dq-axis voltage command values.

The coordinate converter 11 calculates three-phase voltage command values Vu*, Vv*, and Vw* by coordinate-transforming the dq-axis voltage command values Vd* and Vq* from the current controller 19 based on the magnetic pole position information θ* detected by the magnetic pole position detector 4, and outputs the three-phase voltage command values.

The control period calculation unit 15 calculates a control period tc based on the velocity information ω1* calculated by the frequency calculation unit 5, and outputs the control period.

The control interrupt generation unit 17 generates a control interrupt signal int and a current reading signal cl based on a control period fc from the control period calculation unit 15. In the present embodiment, the control interrupt signal int and the current reading signal cl are synchronized with each other and are completely the same signal.

The coordinate converter 7, the coordinate converter 11, and the current controller 19 constituting the control calculation unit 13 operate in response to calling of the control interrupt signal int from the control interrupt generation unit 17.

The DC voltage detection device 6 detects voltage of the DC voltage source 9 and outputs a result of the detection as DC voltage information Vdc.

The PWM controller 12 calculates a duty signal based on the three-phase voltage command values Vu*, Vv*, and Vw* from the coordinate converter 11 and the DC voltage information Vdc from the DC voltage detection device 6, and compares the calculated duty signal with a carrier wave to generate and output a gate signal.

Here, a basic principle of the present invention will be described.

First, a generation principle of current vibration in an overmodulation region of an AC motor and control in synchronous PWM will be described.

FIG. 2 is a diagram illustrating a relationship among a three-phase fundamental wave current, a dq-axis sixth-order harmonic current, and reading timing.

Control of an AC motor is known in which a 6n-th-order component is generated in a dq-axis current in the overmodulation region (e.g., see NPL 1), and when the control period fc becomes close to 6n times (n is a natural number) an inverter output frequency, current vibration occurs.

FIG. 2 illustrates a three-phase fundamental current 61, a dq-axis sixth-order harmonic current 63, reading timing, and influence of a 6n (n=1)-th-order component among the 6n-th-order components on the control. In the present embodiment, the current reading unit 8 reads a current with the control period fc in synchronization with the control calculation unit 13. FIG. 2 illustrates the control period fc that deviates from six times an inverter output frequency f0 by Δf (i.e., when fc=6f0+Δf). At this time, a sixth-order harmonic component i′h6 detected at each point is obtained by (Expression 4) below.

$$\begin{matrix}[ Expression 1 ] & \\ {i}_{h 6}^{′} ( n ) = {I}_{h} cos θ & ( Expression 1 )\end{matrix}$$

$$\begin{matrix}[ Expression 2 ] & \\ {i}_{h 6}^{′} ( n + 1 ) = {I}_{h} cos ( θ + 2 π \frac{6 {f}_{0}}{6 {f}_{0} + Δ f} ) = {I}_{h} cos ( θ - 2 π \frac{Δ f}{6 {f}_{0} + Δ f} ) & ( Expression 2 )\end{matrix}$$

$$\begin{matrix}[ Expression 3 ] & \\ {i}_{h 6}^{′} ( n + 2 ) = {I}_{h} cos ( θ + 2 π \frac{6 {f}_{0}}{6 {f}_{0} + Δ f} \times 2 ) = {I}_{h} cos ( θ - 2 π \frac{Δ f}{6 {f}_{0} + Δ f} \times 2 ) & ( Expression 3 )\end{matrix}$$

$$\begin{matrix}[ Expression 4 ] & \\ {i}_{h 6}^{′} ( n + 3 ) = {I}_{h} cos ( θ + 2 π \frac{6 {f}_{0}}{6 {f}_{0} + Δ f} \times 3 ) = {I}_{h} cos ( θ - 2 π \frac{Δ f}{6 {f}_{0} + Δ f} \times 3 ) & ( Expression 4 )\end{matrix}$$

The current is detected at a frequency (6f0+Δf) according to (Expression 1) to (Expression 4) above, so that the current seems to vibrate at a frequency (−Δf) when viewed in a dq coordinate. An amplitude at this time is an amplitude Ih of a harmonic current.

Here, when a frequency Δf is in a response band of current control, a current that should actually vibrate in the sixth order is regarded as a current vibrating at the frequency Δf, and thus the current control acts to cancel vibration at the frequency Δf. The vibration at the frequency Δf is not originally generated, so that the vibration at Δf is generated when the current control acts. This is a mechanism of the generation of the vibration of the current.

Thus, the generation of the vibration of the current is suppressed in the present embodiment by control of the control period calculation unit 15. Hereinafter, a basic principle and details thereof will be described.

The control period calculation unit 15 includes a lookup table having the velocity information ω1* as an input and the control period fc as an output.

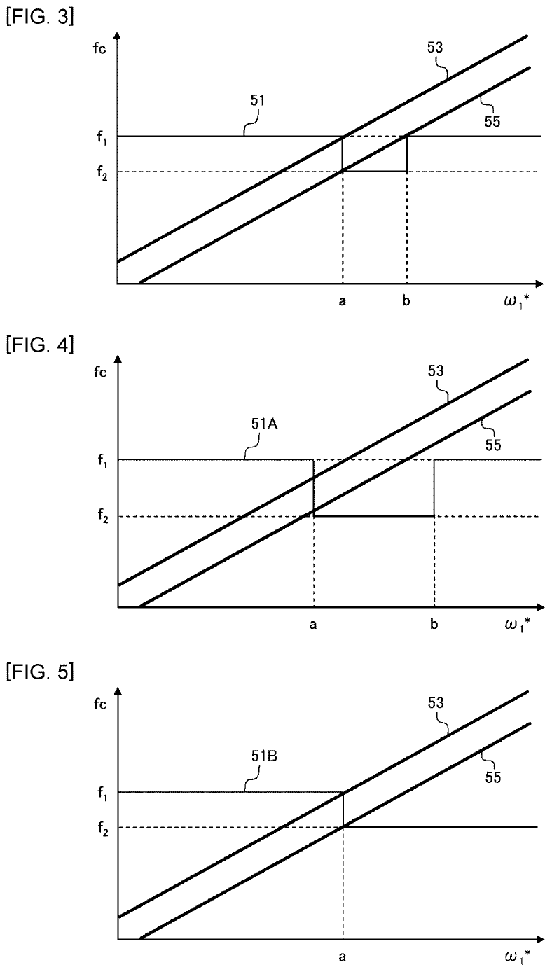

FIG. 3 is a diagram illustrating an example of the lookup table used in the control period calculation unit, in which a horizontal axis indicates the velocity information ω1* and a vertical axis indicates the control period fc.

As illustrated in FIG. 3, a relationship (line 51) between the velocity information ω1* and the control period fc is selected avoiding a selection prohibited band defined by an upper limit 53 and a lower limit 55. Here, an example is illustrated in which the control period fc is set to f1 in a range of the velocity information ω1*<the angular velocity a or angular velocity b≤the velocity information ω1*, and the control period fc is set to f2 in a range of the angular velocity a≤the velocity information ω1*<the angular velocity b. Then, the angular velocity a is acquired when fc set to f1 intersects the upper limit 53 of the selection prohibited band, and the angular velocity b is acquired when fc set to f1 intersects the lower limit 55 of the selection prohibited band.

The upper limit 53 and the lower limit 55 of the selection prohibited band are determined by (Expression 5) below.

$$\begin{matrix}[ Expression 5 ] & \\ 6 {f}_{0} - m \times {f}_{acr} < {f}_{c} < 6 {f}_{0} + m \times {f}_{acr} & ( Expression 5 )\end{matrix}$$

Here, f0 represents the inverter output frequency, and facr represents the cutoff frequency of the current controller 19 in (Expression 5) above. Additionally, a variable m is a positive value, and a setting method thereof will be described below.

An apparent current generated in the dq-axis current within the response band of the current control causes the current vibration, so that the apparent frequency Δf of the dq-axis current harmonic is controlled to be outside the response band of the current control in the present embodiment. In general, the frequency is outside the response band of the current control at a frequency 10 times or more the cutoff frequency face of the current control. Thus, when current is to be detected once in the control period, for example, setting the variable m to 10 enables the frequency Δf to be outside the response band. Considering that some current vibration is allowable, it can be said that the variable m may be set to about 5. As described above, when the control period is set avoiding the selection prohibited band shown in (Expression 5) above, vibration of current at a low frequency can be avoided even with a sixth-order component generated in the dq-axis current in the overmodulation region.

Although the sixth-order component (i.e., when n is 1) has been described as an example in the present embodiment, the above principle applies to all of 6n-th-order subsequent components (i.e., when n is more than 1) such as the 12-th order component, the 18-th order component, and the 24-th order component.

As described above, when the current used for the current control is detected at timing when the current coincides with the control interrupt int, vibration can be avoided by avoiding an integral multiple of 6 as a prohibited band in which the vibration is not generated by the sixth-order current.

Although an example has been described in the present embodiment, in which the control interrupt int and the current reading signal cl completely coincide with each other, a slight difference in timing is allowed to obtain similar effect as long as these signals are in the same period.

Although an example has been described in the present embodiment, in which the control period is changed in accordance with the angular velocity (velocity information ω1*), a similar effect can be obtained by applying the present invention to a configuration in which frequency is changed by the inverter output frequency (that does not coincide with velocity for an induction machine) instead of the angular velocity. Even when the frequency is changed by information other than the angular velocity (e.g., torque), a similar effect can be obtained by setting the control period avoiding the prohibited band determined by the angular velocity.

An automobile is an application having a strict demand for rapid acceleration and deceleration performance, and vibration, so that it can be said that the effect of the present invention appears more remarkably than other applications. Similarly, a railway also has a strict demand for rapid acceleration and deceleration performance, and vibration as with the automobile, and thus is an application in which the effect of the present invention is likely to be exhibited. That is, when the present invention is applied to the automobile and the railway in “control in which a control period is not synchronized with an inverter frequency” that is a method suitable for improving the rapid acceleration and deceleration performance, vibration due to 6f can be suppressed to improve ride comfort of a driver or a passenger.

Although an example has been described in the present embodiment, in which a lookup table is used to determine the control period while avoiding the selection prohibited band in a rectangular manner and at a minimum as illustrated in FIG. 3, the present invention is not limited to this example. For example, a lookup table in which the control period avoids the selection prohibited band may be used as in first to third modifications below, and an effect similar to that of the first embodiment can be obtained.

FIG. 4 is a diagram illustrating a lookup table according to the first modification of the present embodiment. FIG. 4 shows a relationship (line 51A) between the velocity information ω1* and the control period fc that is set to determine a control period while the selection prohibited band is avoided in a rectangular manner with a margin. Here, an example is illustrated in which the control period fc is set to f1 in a range of the velocity information ω1*<the angular velocity a or angular velocity b≤the velocity information ω1*, and the control period fc is set to f2 in a range of the angular velocity a≤the velocity information ω1*<the angular velocity b. However, the angular velocities a and b, and the control periods f1 and f2 are set to prevent the control periods f1 and f2 from taking values on the upper limit 53 and the lower limit 55 of the selection prohibited band, i.e., to have values with a margin from the selection prohibited region.

FIG. 5 is a diagram illustrating a lookup table according to the second modification of the present embodiment. FIG. 5 shows a relationship (line 51B) between the velocity information ω1* and the control period fc that is set to determine a control period in a rectangular manner while the selection prohibited band is avoided stepwise and at the minimum. Here, an example is illustrated in which the control period fc is set to f1 in a range of the velocity information ω1*<the angular velocity a, and the control period fc is set to f2 in a range of the angular velocity a≤the velocity information ω1*. Then, the angular velocity a is acquired when fc set to f1 intersects the upper limit 53 of the selection prohibited band.

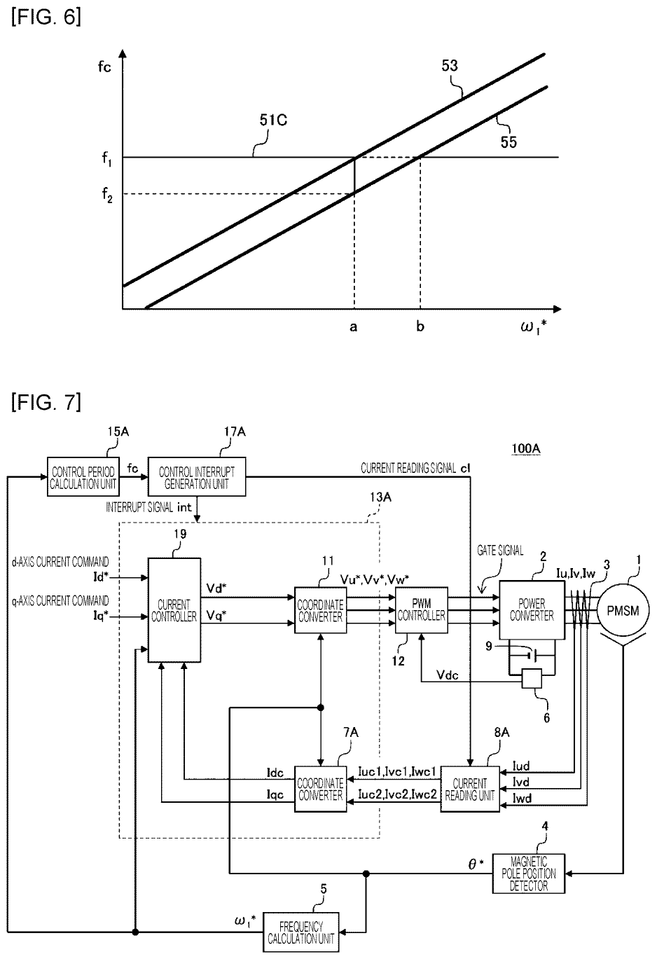

FIG. 6 is a diagram illustrating a lookup table according to the third modification of the present embodiment. FIG. 6 shows a relationship (line 51C) between the velocity information ω1* and the control period fc, the relationship being selected avoiding a selection prohibited band defined by an upper limit 53 and a lower limit 55. Here, an example is illustrated in which the control period fc is set to f1 in a range of the velocity information ω1*<the angular velocity a or angular velocity b≤the velocity information ω1*, and the control period fc is set to a value along the lower limit 55 in a range of the angular velocity a≤the velocity information ω1*<the angular velocity b. Then, the angular velocity a is acquired when fc set to f1 intersects the upper limit 53 of the selection prohibited band, and the angular velocity b is acquired when fc set to f1 intersects the lower limit 55 of the selection prohibited band.

### Second Embodiment

A second embodiment of the present invention will be described with reference to FIGS. 7 to 10.

The present embodiment shows a current reading signal that is controlled to be ON at a period that is double of that of an interrupt signal, and control that is performed according to deviation between three-phase currents read in twice in response to the current reading signal.

In the present embodiment, only differences from the first embodiment will be described, and members similar to those of the first embodiment are denoted by the same reference numerals in the drawings used in the present embodiment, and description thereof will not be described as appropriate.

FIG. 7 is a functional block diagram illustrating a motor control device according to the present embodiment together with a related configuration.

As illustrated in FIG. 7, a motor control device 100A controls power supplied from a DC voltage source 9 to a PMSM 1 through a power converter 2, the motor control device schematically including a phase current detector 3, a magnetic pole position detector 4, a frequency calculation unit 5, a DC voltage detection device 6, coordinate converters 7A and 11, a current reading unit 8A, a PWM controller 12, a control period calculation unit 15A, a control interrupt generation unit 17A, and a current controller 19. The coordinate converters 7A and 11, and the current controller 19 constitute a control calculation unit 13A.

The control interrupt generation unit 17A generates a current reading signal cl to be ON at a period that is double of that of an interrupt signal int and outputs the current read signal.

The current reading unit 8A reads current waveforms Iud, Ivd, and Iwd of three-phase currents when the current reading signal cl becomes ON. At this time, currents at timing of the reading are output as three-phase currents Iuc1, Ivc1, and Iwc1, and currents read last time are output as three-phase currents Iuc2, Ivc2, and Iwc2 to the coordinate converter 7A of the control calculation unit 13A.

The coordinate converter 7A performs coordinate conversion into dq coordinates by correcting deviation between the three-phase currents Iuc1, Ivc1, and Iwc1, and the three-phase currents Iuc2, Ivc2, and Iwc2, which are different in timing of reading, into a rotation angle. Then, a dq-axis current subjected to the coordinate conversion is averaged and output to the current controller 19 as dq-axis current detection values Idc and Iqc.

Here, operation and effect of the present embodiment configured as described above will be described.

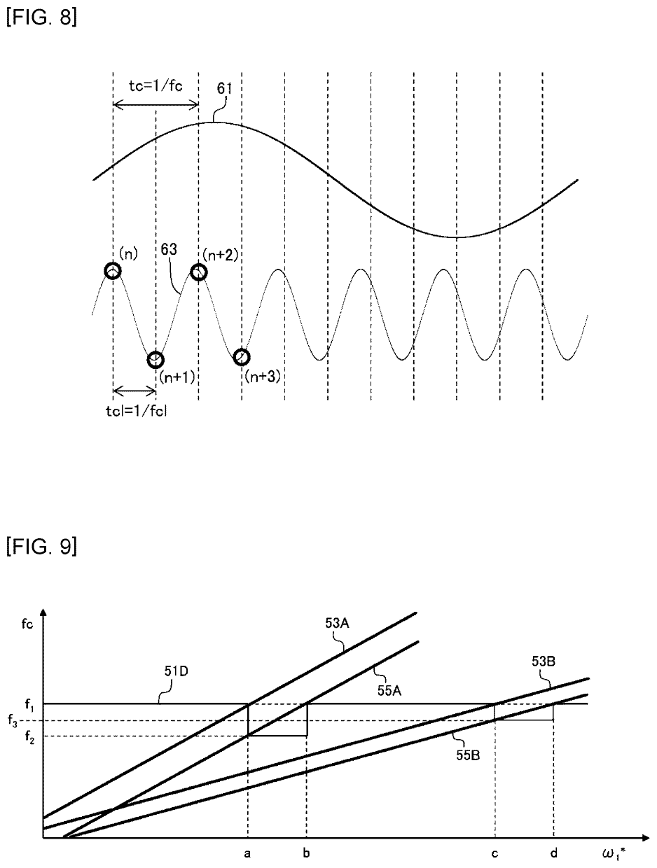

FIG. 8 is a diagram illustrating a relationship among a three-phase fundamental wave current, a dq-axis sixth-order harmonic current, and reading timing. FIG. 8 illustrates a three-phase fundamental current 61, a dq-axis sixth-order harmonic current 63, and the reading timing.

FIG. 8 is illustrated in which the current reading unit 8A reads a current at a double period fc1 set to 2fc in synchronization with the control calculation unit 13A, and a control period fc deviates from six times the inverter output frequency f0 by Δf (i.e., when fc1 is set to 2fc=12f0+2Δf). At this time, a sixth-order harmonic component i′h6 detected at each point is obtained by (Expression 6) to (Expression 9) below.

$$\begin{matrix}[ Expression 6 ] & \\ {i}_{h 6}^{′} ( n ) = {I}_{h} cos θ & ( Expression 6 )\end{matrix}$$

$$\begin{matrix}[ Expression 7 ] & \\ {i}_{h 6}^{′} ( n + 1 ) = {I}_{h} cos ( θ + 2 π \frac{6 {f}_{0}}{12 {f}_{0} + 2 Δ f} ) & ( Expression 7 )\end{matrix}$$

$$\begin{matrix}[ Expression 8 ] & \\ {i}_{h 6}^{′} ( n + 2 ) = {I}_{h} cos ( θ + 2 π \frac{6 {f}_{0}}{12 {f}_{0} + 2 Δ f} \times 2 ) & ( Expression 8 )\end{matrix}$$

$$\begin{matrix}[ Expression 9 ] & \\ {i}_{h 6}^{′} ( n + 3 ) = {I}_{h} cos ( θ + 2 π \frac{6 {f}_{0}}{12 {f}_{0} + 2 Δ f} \times 3 ) & ( Expression 9 )\end{matrix}$$

The current control uses an average value of currents detected twice, so that a sixth-order harmonic component i′h6_c included in each current used for the current control is obtained by (Expression 10) and (Expression 11) below.

$$\begin{matrix}[ Expression 10 ] & \\ {i}_{h 6 \_ c}^{′} ( n + 2 ) = \frac{{I}_{h} cos θ + {I}_{h} cos ( θ + 2 π \frac{6 {f}_{0}}{12 {f}_{0} + 2 Δ f} )}{2} = {I}_{h} sin ( θ - 2 π \frac{Δ f / 2}{12 {f}_{0} + 2 Δ f} ) sin ( - 2 π \frac{Δ f / 2}{12 {f}_{0} + 2 Δ f} ) \approx - {I}_{h} 2 π \frac{0 \text{.5} Δ f}{12 {f}_{0} + 2 Δ f} sin ( θ - 2 π \frac{0 \text{.5} Δ f}{12 {f}_{0} + 2 Δ f} ) & ( Expression 10 )\end{matrix}$$

$$\begin{matrix}[ Expression 11 ] & \\ {i}_{h 6 \_ c}^{′} ( n + 4 ) = \frac{\begin{matrix}{I}_{h} cos ( θ + 2 π \frac{12 {f}_{0}}{12 {f}_{0} + 2 Δ f} ) + \\ {I}_{h} cos ( θ + 2 π \frac{18 {f}_{0}}{12 {f}_{0} + 2 Δ f} )\end{matrix}}{2} \approx - {I}_{h} 2 π \frac{0 \text{.5} Δ f}{12 {f}_{0} + 2 Δ f} sin ( θ - 2 π \frac{2 \text{.5} Δ f}{12 {f}_{0} + 2 Δ f} ) & ( Expression 11 )\end{matrix}$$

The current is detected at a frequency (1210+2Δf) according to (Expression 10) and (Expression 11) above, so that the current seems to vibrate at a frequency (−2Δf) when viewed in the dq coordinate. At this time, the current has an amplitude equal to an amplitude of a harmonic current (Ih×20×0.5Δf÷(12f0+2Δf)). Although the amplitude is smaller than that when a current is detected once in one period of the control period (see the first embodiment), the amplitude increases as the frequency Δf increasing. Thus, vibration similarly occurs (however, the vibration has different frequency and amplitude).

Thus, the generation of the vibration of the current is suppressed in the present embodiment by changing the control period fc from the control period calculation unit 15A in accordance with the velocity ω1*.

The control period calculation unit 15A includes a lookup table having the velocity information ω1* as an input and the control period fc as an output.

FIG. 9 is a diagram illustrating an example of the lookup table used in the control period calculation unit, in which a horizontal axis indicates the velocity information ω1* and a vertical axis indicates the control period fc.

As illustrated in FIG. 9, a relationship (line 51D) between the velocity information ω1* and the control period fc is selected avoiding a selection prohibited band defined by an upper limit 53A and a lower limit 55A, and a selection prohibited band defined by an upper limit 53B and a lower limit 55B. Here, an example is illustrated in which the control period fc is set to f1 in a range of the velocity information ω1*<the angular velocity a, the angular velocity b≤the velocity information ω1*<angular velocity c, or angular velocity d≤the velocity information ω1*, the control period fc is set to f2 in a range of the angular velocity a≤the velocity information ω1*<the angular velocity b, and the control period fc is set to f3 in a range of the angular velocity c≤the velocity information ω1*<the angular velocity d. Here, the angular velocity a is acquired when fc set to f1 intersects the upper limit 53A of the selection prohibited band, the angular velocity b is acquired when fc set to f1 intersects the lower limit 55A of the selection prohibited band, the angular velocity c is acquired when fc set to f1 intersects the upper limit 53B of the selection prohibited band, and the angular velocity d is acquired when fc set to f1 intersects the lower limit 55B of the selection prohibited band.

The upper limit 53A and the lower limit 55A of the selection prohibited band are determined by (Expression 12) below.

$$\begin{matrix}[ Expression 12 ] & \\ 6 {f}_{0} - {m}_{1} \times {f}_{acr} < {f}_{c} < 6 {f}_{0} + {m}_{1} \times {f}_{acr} & ( Expression 12 )\end{matrix}$$

Here, f0 represents the inverter output frequency, and facr represents the cutoff frequency (current control cutoff frequency) of the current controller 19 in (Expression 12) above. Additionally, a variable m1 is a positive value, and a setting method thereof will be described below.

When current is detected twice in the control period, the frequency becomes double of the frequency when current is detected once. Thus, when the variable m1 is set 5, the frequency is 10 times the current control cutoff frequency facr to be outside the response band of the current control. Considering that some current vibration is allowable, it can be said that the variable m1 may be set to about 2.5.

When the current is detected twice, similar vibration occurs even when the control period is around 3 times the inverter output frequency. Thus, a setting prohibition region defined by the upper limit 53B and the lower limit 55B determined by (Expression 13) below is added.

$$\begin{matrix}[ Expression 13 ] & \\ 3 {f}_{0} - k \times {f}_{acr} < {f}_{c} < 3 {f}_{0} + k \times {f}_{acr} & ( Expression 13 )\end{matrix}$$

Here, k is a positive value, and is basically set to m1/2 in (Expression 13) above.

Subsequently, a reason why similar vibration occurs even when the control period is around three times the inverter output frequency will be described below.

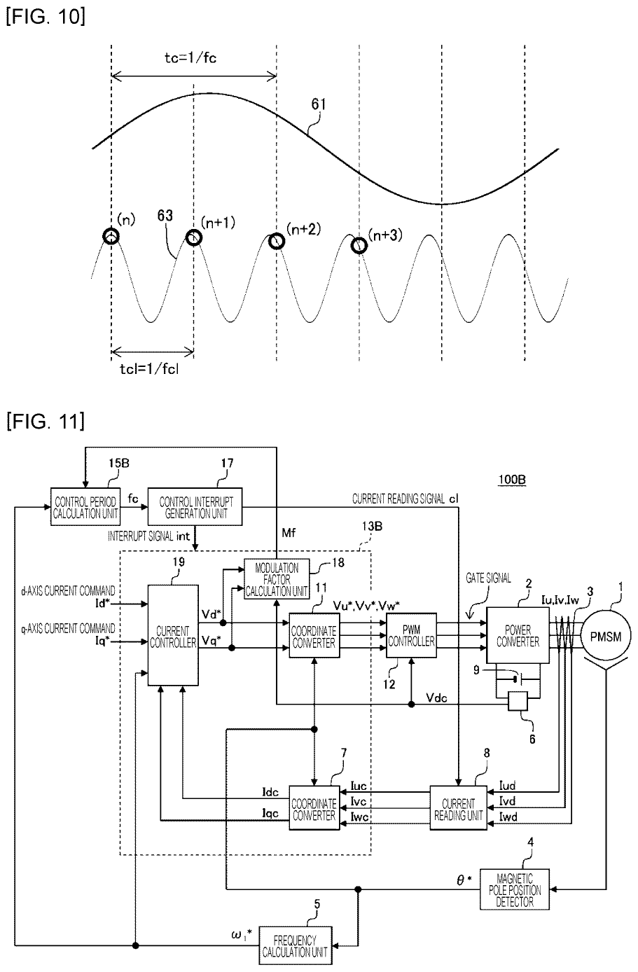

FIG. 10 is a diagram illustrating a relationship among a three-phase fundamental wave current, a dq-axis sixth-order harmonic current, and reading timing. FIG. 10 illustrates a three-phase fundamental current 61, a dq-axis sixth-order harmonic current 63, and the reading timing.

FIG. 10 is illustrated in which the current reading unit 8A reads a current at a double period fc1 set to 2fc in synchronization with the control calculation unit 13A, and a control period fc deviates from three times the inverter output frequency f0 by Δf (i.e., when fc1 is set to 2fc=6f0+2Δf). At this time, a sixth harmonic component i″h6 detected at each point is obtained by (Expression 14) to (Expression 17) below.

$$\begin{matrix}[ Expression 14 ] & \\ {i}_{h 6}^{″} ( n ) = {I}_{h} cos θ & ( Expression 14 )\end{matrix}$$

$$\begin{matrix}[ Expression 15 ] & \\ {i}_{h 6}^{″} ( n + 1 ) = {I}_{h} cos ( θ + 2 π \frac{6 {f}_{0}}{6 {f}_{0} + 2 Δ f} ) = {I}_{h} cos ( θ + 2 π \frac{2 Δ f}{6 {f}_{0} + 2 Δ f} ) & ( Expression 15 )\end{matrix}$$

$$\begin{matrix}[ Expression 16 ] & \\ {i}_{h 6}^{″} ( n + 2 ) = {I}_{h} cos ( θ + 2 π \frac{6 {f}_{0}}{6 {f}_{0} + 2 Δ f} \times 2 ) = {I}_{h} cos ( θ + 2 π \frac{2 Δ f}{6 {f}_{0} + 2 Δ f} \times 2 ) & ( Expression 16 )\end{matrix}$$

$$\begin{matrix}[ Expression 17 ] & \\ {i}_{h 6}^{″} ( n + 3 ) = {I}_{h} cos ( θ + 2 π \frac{6 {f}_{0}}{6 {f}_{0} + 2 Δ f} \times 3 ) = {I}_{h} cos ( θ + 2 π \frac{2 Δ f}{6 {f}_{0} + 2 Δ f} \times 3 ) & ( Expression 17 )\end{matrix}$$

The current control uses an average value of currents detected twice, so that a sixth-order harmonic component i″h6_c included in each current used for the current control is obtained by (Expression 18) and (Expression 19) below.

$$\begin{matrix}[ Expression 18 ] & \\ {i}_{h 6 \_ c}^{″} ( n + 2 ) = \frac{{I}_{h} cos θ + {I}_{h} cos ( θ + 2 π \frac{2 Δ f}{6 {f}_{0} + 2 Δ f} )}{2} = {I}_{h} cos ( θ + 2 π \frac{Δ f}{6 {f}_{0} + 2 Δ f} ) cos ( 2 π \frac{Δ f}{6 {f}_{0} + 2 Δ f} ) \approx {I}_{h} cos ( θ + 2 π \frac{Δ f}{6 {f}_{0} + 2 Δ f} ) & ( Expression 18 )\end{matrix}$$

$$\begin{matrix}[ Expression 19 ] & \\ {i}_{h 6 \_ c}^{′} ( n + 4 ) = \frac{\begin{matrix}{I}_{h} cos ( θ + 2 π \frac{4 Δ f}{6 {f}_{0} + 2 Δ f} ) + \\ {I}_{h} cos ( θ + 2 π \frac{6 Δ f}{6 {f}_{0} + 2 Δ f} )\end{matrix}}{2} = {I}_{h} cos ( θ + 2 π \frac{5 Δ f}{6 {f}_{0} + 2 Δ f} ) cos ( 2 π \frac{Δ f}{6 {f}_{0} + 2 Δ f} ) \approx {I}_{h} cos ( θ + 2 π \frac{5 Δ f}{6 {f}_{0} + 2 Δ f} ) & ( Expression 19 )\end{matrix}$$

The current is detected at a frequency (6f0+2Δf) according to (Expression 18) and (Expression 19) above, so that the current seems to vibrate at a frequency 4Δf when viewed in the dq coordinate. An amplitude at this time is an amplitude Ih of a harmonic current. The amplitude is equal to that when a current is detected once in one control period (see the first embodiment), and vibration is generated similarly. Then, the frequency is double, so that the prohibited band for suppressing vibration may be half.

Other configurations are similar to those of the first embodiment.

Even the present embodiment configured as described above can obtain effect as in the first embodiment.

When the current used for the current control is obtained by averaging currents detected multiple times at equal intervals within the control period, an integral multiple of (6=the number of times of current detection) as a prohibited band for preventing generation of vibration by the sixth-order current needs to be avoided. Although the present embodiment shows an example in which current is detected twice, similar setting can avoid vibration even when the number of times of detection is increased. When the control interrupt int and the current reading signal cl each have a double period, a similar effect can be obtained even when phases are shifted. When the lookup table is set in which the control period fc is set avoiding the prohibited band, a similar effect can be obtained even when the lookup table is different from the lookup table illustrated in FIG. 9 in the present embodiment.

### Third Embodiment

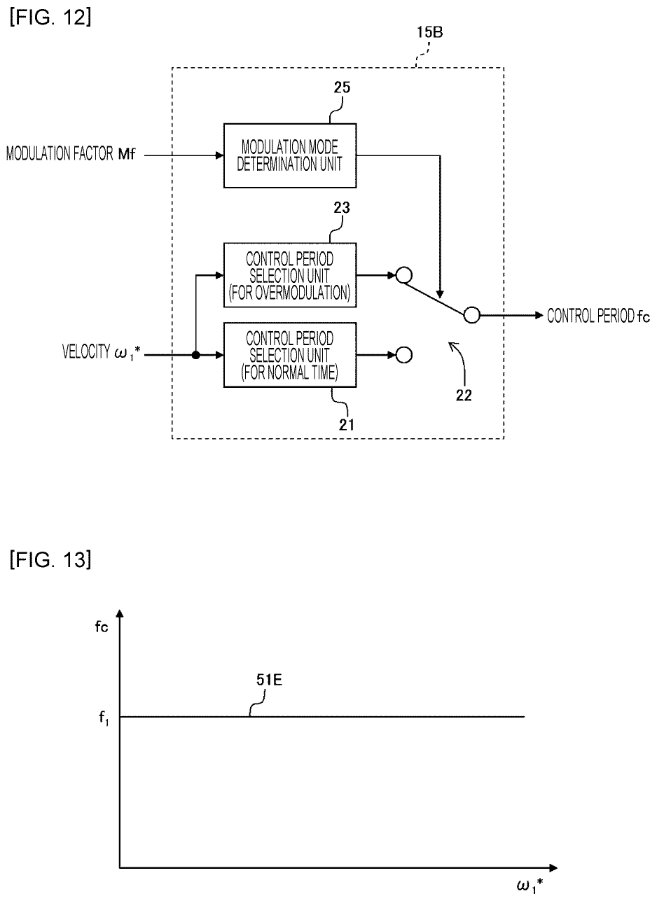

A third embodiment of the present invention will be described with reference to FIGS. 11 to 13.

The present embodiment shows a control period that is controlled in accordance with a modulation factor calculated from a dq-axis voltage command value and DC voltage.

In the present embodiment, only differences from the first embodiment will be described, and members similar to those of the first embodiment are denoted by the same reference numerals in the drawings used in the present embodiment, and description thereof will not be described as appropriate.

FIG. 11 is a functional block diagram illustrating a motor control device according to the present embodiment together with a related configuration.

As illustrated in FIG. 11, the motor control device 100B controls power supplied from the DC voltage source 9 to the PMSM 1 through the power converter 2, the motor control device schematically including a phase current detector 3, a magnetic pole position detector 4, a frequency calculation unit 5, a DC voltage detection device 6, coordinate converters 7 and 11, a current reading unit 8, a PWM controller 12, a control period calculation unit 15B, a control interrupt generation unit 17, a modulation factor calculation unit 18, and a current controller 19. The coordinate converters 7 and 11, the modulation factor calculation unit 18, and the current controller 19 constitute a control calculation unit 13B.

The modulation factor calculation unit 18 calculates a modulation factor Mf based on a dq-axis voltage command values Vd* and Vq* from the current controller 19 and DC voltage Vdc from the DC voltage detection device 6, and outputs the modulation factor Mf to the control period calculation unit 15B.

FIG. 12 is a functional block diagram illustrating processing contents of the control period calculation unit.

As illustrated in FIG. 12, the control period calculation unit 15B calculates a control period fc based on velocity information ω1* from the frequency calculation unit 5 and a modulation factor Mf from the modulation factor calculation unit 18 and outputs the control period fc to the control interrupt generation unit 17, the control period calculation unit schematically including a control period selection unit (for normal time) 21, a control period selection unit 23 (for overmodulation), a modulation mode determination unit 25, and a switching unit 22.

The modulation mode determination unit 25 determines whether control of the PMSM1 is performed in the overmodulation region, based on the modulation factor Mf.

The control period selection unit (for overmodulation) 23 selects the control period fc to be used when control is performed in the overmodulation region, based on a lookup table. The control period selection unit (for overmodulation) 23 uses the lookup table illustrated in FIG. 2 of the first embodiment, for example. Consequently, the control period fc for avoiding vibration of current that may occur during control in the overmodulation region is selected.

The control period selection unit (for normal time) 21 selects the control period fc to be used when the control is not performed in the overmodulation region according to a lookup table illustrated in FIG. 13. FIG. 13 is a diagram illustrating an example of the lookup table used in the control period calculation unit, in which a horizontal axis indicates the velocity information ω1* and a vertical axis indicates the control period fc. When the control is performed in a range other than the overmodulation region, the prohibited band does not need to be considered. Thus, a lookup table is used in which a relationship (line 51E) between the velocity information ω1* and the control period fc allows the control period fc to be set to f1 regardless of the velocity information ω1* as illustrated in FIG. 13. The control period f1 at this time can be set high because suppression of vibration of current does not need to be considered.

When the modulation mode determination unit 25 determines that control is performed in the overmodulation region, the switching unit 22 switches output to the control interrupt generation unit 17 to the control period fc selected by the control period selection unit (for overmodulation) 23. When the modulation mode determination unit 25 determines that control is not performed in the overmodulation region, the switching unit 22 switches output to the control interrupt generation unit 17 to the control period fc (e.g., fc set to f1) selected by the control period selection unit (for normal time) 21.

Other configurations are similar to those of the first embodiment.

Even the present embodiment configured as described above can obtain effect as in the first embodiment.

The present embodiment is configured to select the control period fc for avoiding the prohibited band only in the overmodulation region where the vibration occurs in consideration of vibration of 6f that does not occur in the dq-axis current in the normal region (except the overmodulation region). This configuration enables vibration to be suppressed during overmodulation, and the control period fc for normal time to be set high, so that control performance can be improved.

### Fourth Embodiment

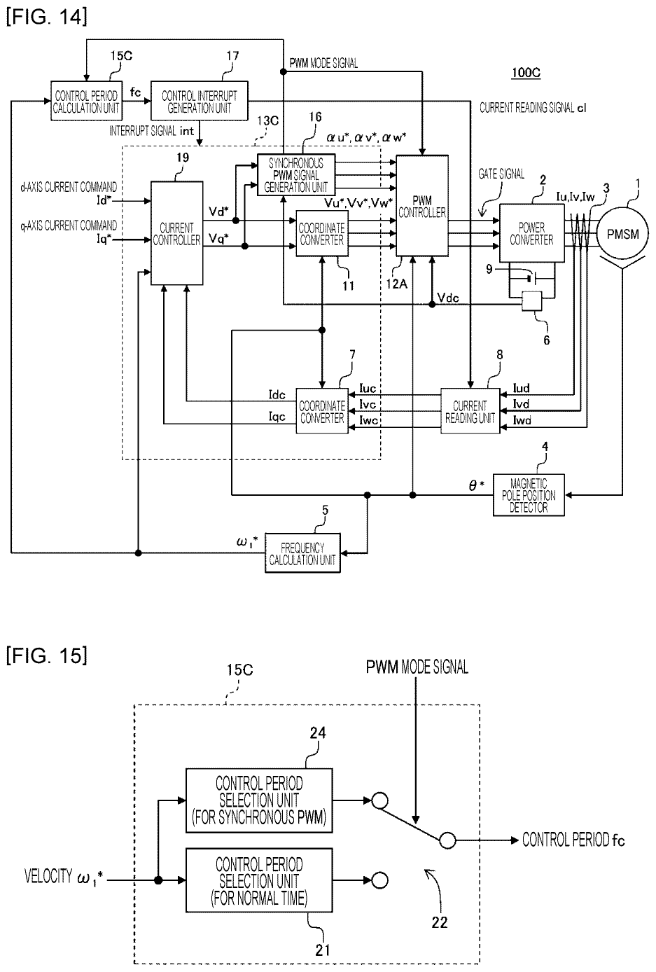

A fourth embodiment of the present invention will be described with reference to FIGS. 14 and 15.

The present embodiment shows a method for calculating a control period and a method for controlling PWM, the methods being changed depending on whether control is synchronous PWM or asynchronous PWM.

In the present embodiment, only differences from the first embodiment will be described, and members similar to those of the first embodiment are denoted by the same reference numerals in the drawings used in the present embodiment, and description thereof will not be described as appropriate.

FIG. 14 is a functional block diagram illustrating a motor control device according to the present embodiment together with a related configuration.

As illustrated in FIG. 14, a motor control device 100C controls power supplied from a DC voltage source 9 to a PMSM 1 through a power converter 2, the motor control device schematically including a phase current detector 3, a magnetic pole position detector 4, a frequency calculation unit 5, a DC voltage detection device 6, coordinate converters 7 and 11, a current reading unit 8, a PWM controller 12A, a control period calculation unit 15C, a synchronous PWM signal generation unit 16, a control interrupt generation unit 17, and a current controller 19. The coordinate converters 7 and 11, the synchronous PWM signal generation unit 16, and the current controller 19 constitute a control calculation unit 13C.

The synchronous PWM signal generation unit 16 calculates firing angles αu*, αv*, and αw* used for synchronous PWM based on dq-axis voltage command values Vd* and Vq* from the current controller 19 and DC voltage Vdc from the DC voltage detection device 6, and outputs the firing angles to the PWM controller 12A.

The synchronous PWM signal generation unit 16 also calculates a modulation factor based on the dq-axis voltage command values Vd* and Vq* from the current controller 19 and the DC voltage Vdc from the DC voltage detection device 6 to determine whether control is synchronous PWM control (referred to below as a synchronous PWM mode) or asynchronous PWM control (referred to below asynchronous PWM mode) based on the calculated modulation factor, and outputs a PWM mode signal indicating any one of the modes determined to the control period calculation unit 15C and the PWM controller 12A.

When the PWM mode signal from the synchronous PWM signal generation unit 16 indicates the synchronous PWM mode, the PWM controller 12A compares the firing angles αu*, αv*, and αw* from the synchronous PWM signal generation unit 16 with a magnetic pole position θ* from the magnetic pole position detector 4 to generate a gate signal. In contrast, when the PWM mode signal from the synchronous PWM signal generation unit 16 indicates the asynchronous PWM mode, the PWM controller 12A calculates a duty signal based on the three-phase voltage command values Vu*, Vv*, and Vw* from the coordinate converter 11 and DC voltage information Vdc from the DC voltage detection device 6, and compares the calculated duty signal with a carrier wave to generate a gate signal, and then outputs the gate signal to the power converter 2.

FIG. 15 is a functional block diagram illustrating processing contents of the control period calculation unit.

As illustrated in FIG. 15, the control period calculation unit 15C calculates a control period fc based on velocity information ω1* from the frequency calculation unit 5 and a modulation factor Mf from the modulation factor calculation unit 18 and outputs the control period fc to the control interrupt generation the control period calculation unit schematically including a control period selection unit (for normal time) 21, a control period selection unit 24 (for synchronous PWM), and a switching unit 22.

The control period selection unit (for synchronous PWM) 24 selects the control period fc to be used in the synchronous PWM mode based on a lookup table. The control period selection unit (synchronous PWM) 24 uses the lookup table illustrated in FIG. 2 of the first embodiment, for example. Consequently, the control period fc for avoiding vibration of current that may occur during control in the synchronous PWM is selected.

The control period selection unit (for normal time) 21 selects the control period fc to be used in the asynchronous PWM mode according to the lookup table. The control period selection unit (for normal time) uses the lookup table illustrated in FIG. 13 of the third embodiment, for example. This configuration does not require consideration of suppression of vibration of current, and thus enables the control period fc to be set high for the asynchronous PWM mode that does not need to consider a prohibited band.

When the PWM mode signal from the synchronous PWM signal generation unit 16 indicates the synchronous PWM mode, the switching unit 22 switches the output to the control interrupt generation unit 17 to the control period fc selected by the control period selection unit (for synchronous PWM) 24. When the PWM mode signal from the synchronous PWM signal generation unit 16 indicates the asynchronous PWM mode, the switching unit 22 switches the output to the control interrupt generation unit 17 to the control period fc selected by the control period selection unit (for normal time) 21.

Other configurations are similar to those of the first embodiment.

Even the present embodiment configured as described above can obtain effect as in the first embodiment.

The present embodiment is configured to select the control period fc for avoiding the prohibited band only in the overmodulation region where the vibration occurs in consideration of vibration of 6f that does not occur in the dq-axis current in the normal region). This configuration enables vibration to be suppressed during synchronous PWM, and the control period fc for normal time to be set high, so that control performance can be improved.

### Fifth Embodiment

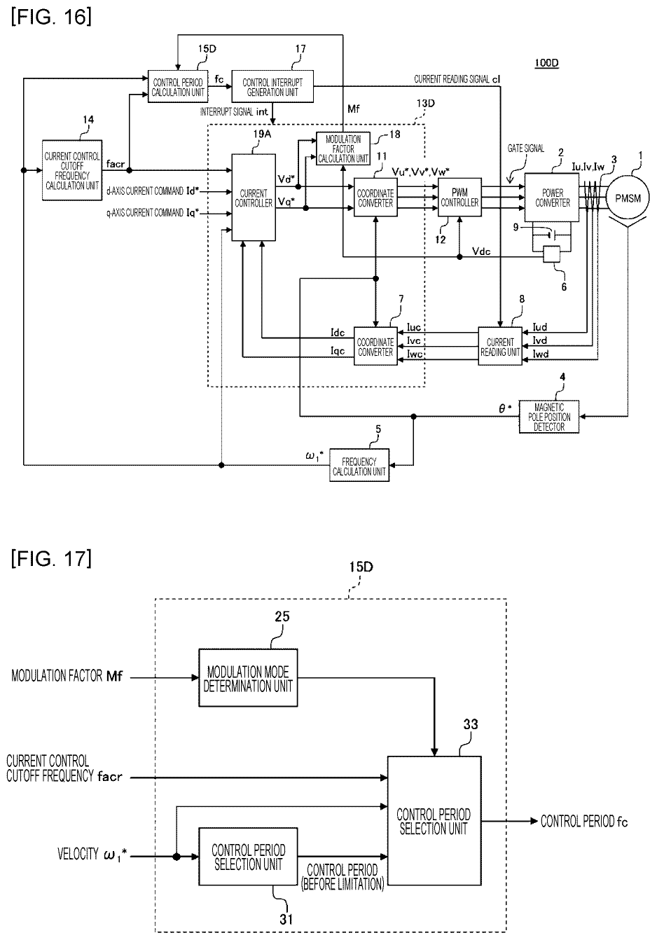

A fifth embodiment of the present invention will be described with reference to FIGS. 16 and 17.

The present embodiment shows a gain of current control, the gain being changed in accordance with a cutoff frequency calculated based on velocity information.

In the present embodiment, only differences from the third embodiment will be described, and members similar to those of the third embodiment are denoted by the same reference numerals in the drawings used in the present embodiment, and description thereof will not be described as appropriate.

FIG. 16 is a functional block diagram illustrating a motor control device according to the present embodiment together with a related configuration.

As illustrated in FIG. 16, a motor control device 100D controls power supplied from a DC voltage source 9 to a PMSM 1 through a power converter 2, the motor control device schematically including a phase current detector 3, a magnetic pole position detector 4, a frequency calculation unit 5, a DC voltage detection device 6, coordinate converters 7 and 11, a current reading unit 8, a PWM controller 12, a current control cutoff frequency calculation unit control period calculation unit 15D, a control interrupt generation unit 17, a modulation factor calculation unit 18, and a current controller 19A. The coordinate converters 7 and 11, the modulation factor calculation unit 18, and the current controller 19A constitute a control calculation unit 13D.

The current control cutoff frequency calculation unit 14 calculates and changes a current control cutoff frequency facr according to velocity information ω1* from the frequency calculation unit 5, and outputs the current control cutoff frequency to the current controller 19.

The current controller 19A changes the gain of the current control in accordance with the current control cutoff frequency facr from the current control cutoff frequency calculation unit 14.

FIG. 17 is a functional block diagram illustrating processing contents of the control period calculation unit.

As illustrated in FIG. 17, the control period calculation unit 15D calculates a control period fc based on the velocity information ω1* from the frequency calculation unit 5, a modulation factor Mf from the modulation factor calculation unit 18, and the current control cutoff frequency facr from the current control cutoff frequency calculation unit 14, and outputs the control period fc to the control interrupt generation unit 17, the control period calculation unit schematically including a modulation mode determination unit 25 and control period selection units 31 and 33.

The modulation mode determination unit 25 determines whether control of the PMSM1 is performed in the overmodulation region, based on the modulation factor Mf.

For example, the control period selection unit 31 selects the control period fc according to the lookup table illustrated in FIG. 13. The lookup table illustrated in FIG. 13 sets the control period fc for when the prohibited band does not need to be considered.

When the modulation mode determination unit 25 determines that control is performed in the overmodulation region, the control period selection unit 33 changes a control period (before limitation) from the control period selection unit 31 to prevent the control period from entering the prohibited band (see (Expression 5) of first embodiment, FIG. 13, etc.) based on the current control cutoff frequency facr from the current control cutoff frequency calculation unit 14, and outputs the changed control period as the control period fc to the control interrupt generation unit 17.

Other configurations are similar to those of the third embodiment.

Even the present embodiment configured as described above can obtain effect as in the third embodiment.

The present embodiment is also compatible with when the current control cutoff frequency is made variable, and enables suppressing vibration of current even when the current control cutoff frequency facr changes according to the velocity information ω1*.

Although an example of a configuration has been described, in which the current control cutoff frequency is changed according to the velocity information ω1*, in the present embodiment, the present invention is not limited thereto. For example, even a configuration, in which the current control cutoff frequency is changed according to other information such as a torque command value, enables obtaining effect as in the present embodiment.

### Sixth Embodiment

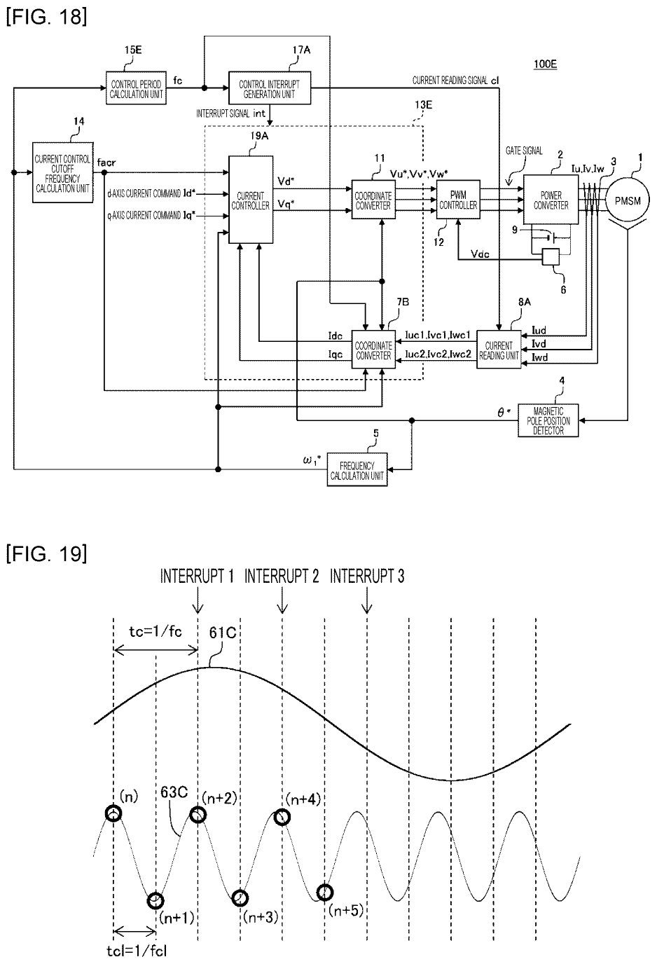

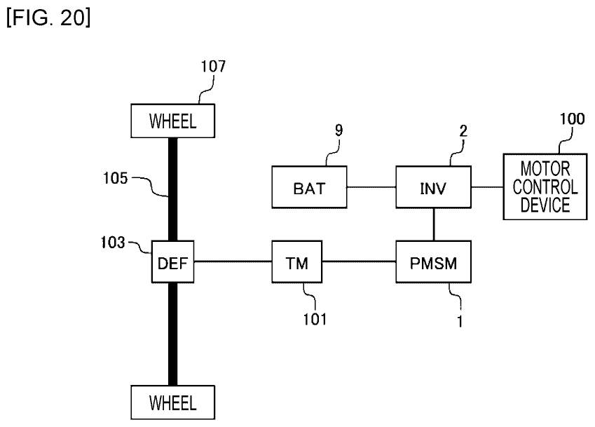

A sixth embodiment 44 the present invention will be described with reference to FIGS. 18 and 19.

The present embodiment shows a current reading signal that is controlled to be ON at a period that is double of that of an interrupt signal, and a gain of current control, the gain being changed in accordance with a cutoff frequency calculated based on velocity information when control is performed according to deviation between three-phase currents read in twice in response to the current reading signal.

In the present embodiment, only differences from the second embodiment will be described, and members similar to those of the second embodiment are denoted by the same reference numerals in the drawings used in the present embodiment, and description thereof will not be described as appropriate.

FIG. 18 is a functional block diagram illustrating a motor control device according to the present embodiment together with a related configuration.

As illustrated in FIG. 18, a motor control device 100E controls power supplied from a DC voltage source 9 to a PMSM 1 through a power converter 2, the motor control device schematically including a phase current detector 3, a magnetic pole position detector 4, a frequency calculation unit 5, a DC voltage detection device 6, coordinate converters 7B and 11, a current reading unit 8A, a PWM controller 12, a current control cutoff frequency calculation unit 14, a control period calculation unit 15E, a control interrupt generation unit 17A, and a current controller 19A. The coordinate converters 7B and 11, and the current controller 19A constitute a control calculation unit 13E.

The control interrupt generation unit 17A generates a current reading signal cl to be ON at a period that is double of that of an interrupt signal int and outputs the current read signal.

The current control cutoff frequency calculation unit 14 calculates and changes a current control cutoff frequency facr according to velocity information ω1* from the frequency calculation unit 5, and outputs the current control cutoff frequency to the current controller 19.

The current controller 19A changes the gain of the current control in accordance with the current control cutoff frequency facr from the current control cutoff frequency calculation unit 14.

For example, the control period calculation unit 15E selects the control period fc according to the lookup table illustrated in FIG. 13. The lookup table illustrated in FIG. 13 sets the control period fc for when the prohibited band does not need to be considered.

The coordinate converter 7B determines whether the control period fc is in the prohibited band (see (Expression 12), (Expression 13), FIG. 9, and the like of the second embodiment) based on the velocity information ω1* from the frequency calculation unit 5, the control period fc from the control period calculation unit 15E, and the current control cutoff frequency facr from the current control cutoff frequency calculation unit 14.

When determining that the control period fc does not enter the forbidden band, the coordinate converter 7B performs coordinate conversion into dq coordinates by correcting deviation between the three-phase currents Iuc1, Ivc1, and Iwc1, and the three-phase currents Iuc2, Ivc2, and Iwc2, which are different in timing of reading, into a rotation angle. Then, a dq-axis current subjected to the coordinate conversion is averaged and output to the current controller 19A as dq-axis current detection values Idc and Iqc.

When determining that the control period fc enters the prohibited band, the coordinate converter 7B switches to a method for alternately calculating the dq-axis current detection values Idc and Iqc, and then outputs the calculated dq-axis current detection values Idc and Iqc to the current controller 19A.

FIG. 19 is a diagram illustrating a relationship among a three-phase fundamental wave current, a dq-axis sixth-order harmonic current, and reading timing. FIG. 19 illustrates a three-phase fundamental current 61C, a dq-axis sixth-order harmonic current 63C, and the reading timing.

As illustrated in FIG. 19, the method for alternately calculating the dq-axis current detection values Idc and Iqc uses a value of (n) an interrupt 1, a value of (n+3) at an interrupt 2, and a value of (n+4) at an interrupt 3. Consequently, a sixth-order component appears as a harmonic component on the dq axis, so that the sixth-order component can be outside a response band by current control. That is, the control period can be made constant, and control response can be improved.

Other configurations are similar to those of the second embodiment.

Even the present embodiment configured as described above can obtain effect as in the second embodiment.

### Supplementary Note

The present invention is not limited to the above embodiments, and includes various modifications and combinations without departing from the gist of the present invention. The present invention is also not limited to a configuration including every configuration described in each of the above embodiments, and includes a configuration in which a part of the configuration is deleted.

For example, the configurations of the third embodiment and the fourth embodiment may be combined to avoid the prohibited band only for the synchronous PWM or the overmodulation region. Configurations for the synchronous PWM and the overmodulation region have a common feature having a nonconstant switching period. Thus, considering both the configurations for the synchronous PWM and the overmodulation region, it can be said that the prohibited band can be configured while avoiding only a region having a nonconstant switching period.

### REFERENCE SIGNS LIST

2 power converter
3 phase current detector
4 magnetic pole position detector
5 frequency calculation unit
6 DC voltage detection device
7, 7A, 7B coordinate converter
8, 8A current reading unit
9 DC voltage source
11 coordinate converter
12, 12A PWM controller
13, 13A, 13B, 13C, 13D, 13E control calculation unit
14 current control cutoff frequency calculation unit
15, 15A, 15B, 15C, 15D, 15E control period calculation unit
16 synchronous PWM signal generation unit
17, 17A control interrupt generation unit
18 modulation factor calculation unit
19, 19A current controller
21, 23, 24, 33 control period selection unit
22 switching unit
25 modulation mode determination unit
31 control period selection unit
61, 61C three-phase fundamental current
63, 63C dq-axis sixth-order harmonic current
100, 100A, 100B, 100C, 100D, 100E motor control device
101 transmission
103 differential gear gear
drive shaft
107 wheel

1. A motor control device that outputs voltage to be applied to an AC motor based on an output voltage command value, the motor control device comprising:
a control period calculation unit that determines a control period in accordance with a fundamental wave frequency of the AC motor and a cutoff frequency of current control;
a control interrupt generation unit that determines a control interrupt based on the control period determined by the control period calculation unit;
a current controller that controls the output voltage command value based on the control interrupt determined by the control interrupt generation unit; and
a PWM controller that controls output of voltage by PWM in accordance with the output voltage command value controlled by the current controller.

2. The motor control device according to claim 1, wherein the control period calculation unit determines the control period to be larger than a range of 6n-th-order of the fundamental wave frequency±10 times the cutoff frequency of the current control.

3. The motor control device according to claim 2, wherein the control period calculation unit determines the control period to be larger than the range of 6n-th-order of the fundamental wave frequency±10 times the cutoff frequency of the current control only when the PWM controller has a nonconstant switching period.

4. The motor control device according to claim 1, wherein the control period calculation unit determines a control period in accordance with the fundamental frequency of the AC motor, the cutoff frequency of the current control, and a modulation factor.

5. The motor control device according to claim 1, wherein the current controller changes a gain of the current control based on a control interrupt determined by the control interrupt generation unit and the cutoff frequency.

6. An electric drive vehicle equipped with an AC motor, the electric drive vehicle comprising the motor control device according to claim 1 that outputs voltage to be applied to the AC motor.
